(19) United States
(12) Patent Application Publication
(10) Pub. No.: US 2004/0250088 A1
(43) Pub. Date: Dec. 9, 2004

(54) Apparatus using a password lock to start the booting procedure of a microprocessor

(76) Inventor: Jwo-Lun Chen, Taipei (TW)

Correspondence Address: NATH & ASSOCIATES, 1030 15th STREET, NW, 6TH FLOOR, WASHINGTON, DC, 20005, US

(21) Appl. No.: 10/440,160

(22) Filed: May 19, 2003

(51) Int. Cl. H04L 9/32

(52) U.S. Cl. 713/189

(57) ABSTRACT

An apparatus using a password lock to start the booting procedure of a microprocessor is disclosed, wherein said apparatus comprises an internal keyboard to provide users a method to input the password; a keyboard controller to store the set password and to respond to said internal keyboard to determine whether said password inputted by the users is correct; and a D/D module to respond to said keyboard controller to start the booting procedure of said microprocessor when said users input the correct password.

### FIELD OF THE INVENTION

This invention relates to a password lock apparatus for protecting the microprocessor production, and specifically relates to an apparatus installed in a notebook and a method to start the notebook by inputting a password.

### BACKGROUND OF THE INVENTION

Today, many kinds of new electrical products with more functions are manufactured each day, and these new products usually are required to be lighter, thinner, shorter and smaller to match the present life style, wherein the notebook computer is a typical example. The portable scanner, radio, PDA and electric dictionary and so on are popular and are extensively applied to many things due to their many digital data processing functions.

Referring to FIG. 1, it shows a notebook 10, wherein the notebook includes the top 12 which connects with the side of the host 18, and a monitor 14 is included in the top 12 used as a display interface when users use the notebook. The top surface of the host 18 includes keyboard 16 for users to input instructions to operate the computer. The top surface of the host 18 also includes a pad 20 to act as a mouse for the notebook. It is important to note that the switching device 22 is always installed on the side of the host 18 to switch the notebook on or off.

It must first be considered that carrying a notebook is very convenient, therefore, notebook owners should use a password to protect their computer from unauthorized usage. However, for the traditional notebook, the required password step follows the booting procedure. That means the required password window is displayed after the notebook's operating system is started. This kind of password entering procedure has many drawbacks. For example, a person who has skill in designing the booting procedure may easily guess the password and then control the computer because the operating system loaded. Even if the intruder never figured out the password to control the computer, he may leave the notebook switched on to exhaust the battery.

The traditional notebook's password lock design always stores the password in the RAM of the CMOS. However, the intruder could clear the CMOS or remove the battery to to reach the stored password. For this kind of storing password design in the ROM of the BIOS, the invader may attack the BIOS directly to change the password. Therefore, both the above methods may not provide efficient protection. Although the password is stored in an EEPROM device in some notebook designs, which may provide better protection, this kind of design requires an additional EEPROM device, which results in a production cost increase and also requires an additional signal line to control the EEPROM. However, under the break situation of the EEPROM or the additional signal line, the notebook will not be started.

### SUMMARY OF THE INVENTION

According to the background of the invention, it is therefore an objective of the present invention to provide a password lock to prevent the microprocessor from being started by an intruder.

It is another objective of the present invention to provide a kind of treatment method of utilizing keyboard controller (KCB) to process the inputted password and booting procedure.

According to the above objectives, the present invention discloses an apparatus that may start the notebook's booting procedure by inputting a password. The apparatus comprises an internal keyboard to provide the users a method to input a password and a keyboard controller to respond to the internal keyboard command to determine whether the inputted password is correct, wherein the keyboard controller includes a memory to record the set password. The memory includes a main feature block to store the data relative to the keyboard controller operation function and also includes a special block to store the data relative to the password and the basic input/output system data. The above apparatus, according to the present invention, further includes a D/D module to respond to the keyboard controller. When the user inputs the correct password, the apparatus, according to the present invention, will start the notebook's booting procedure.

### BRIEF DESCRIPTION OF THE DRAWINGS

For a more complete understanding of the invention, references are made to the following detailed description of the preferred embodiment taken in conjunction with the accompanying drawings in which:

FIG. 1 is a block diagram illustrating a notebook;

FIG. 2 is a configuration diagram illustrating the apparatus set on a notebook according to the present invention that may start the booting procedure by inputting the password;

FIG. 3 shows a configuration diagram illustrating the keyboard controller memory that may store the set password; and

FIG. 4 shows how to apply the present invention apparatus to a notebook to start a booting procedure step.

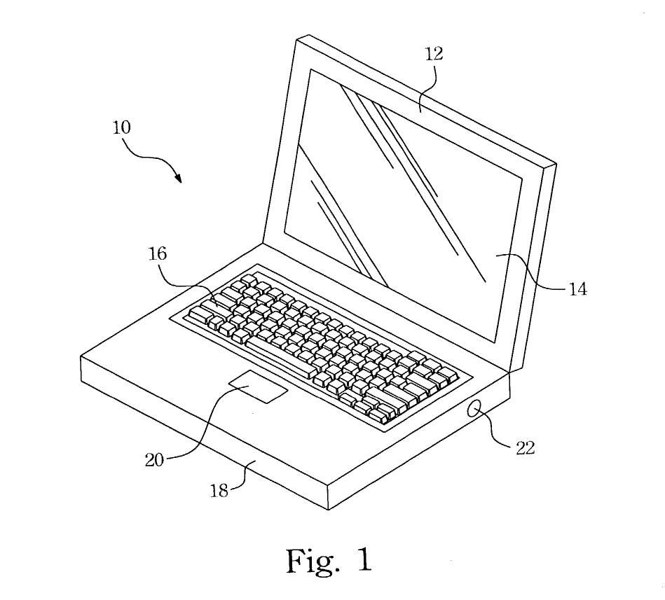

### DETAILED DESCRIPTION OF THE PREFERRED EMBODIMENT

The present invention discloses an apparatus and a method to utilize the keyboard controller to store the password. Utilizing the ROM built in to the keyboard controller to store the password may efficiently provide the users a method to key in the password directly from the internal keyboard in order to switch on the notebook or other similar things. On the other hand, the apparatus according to the present invention may also be applied on other relative production including microprocessor. The detail description is as follows.

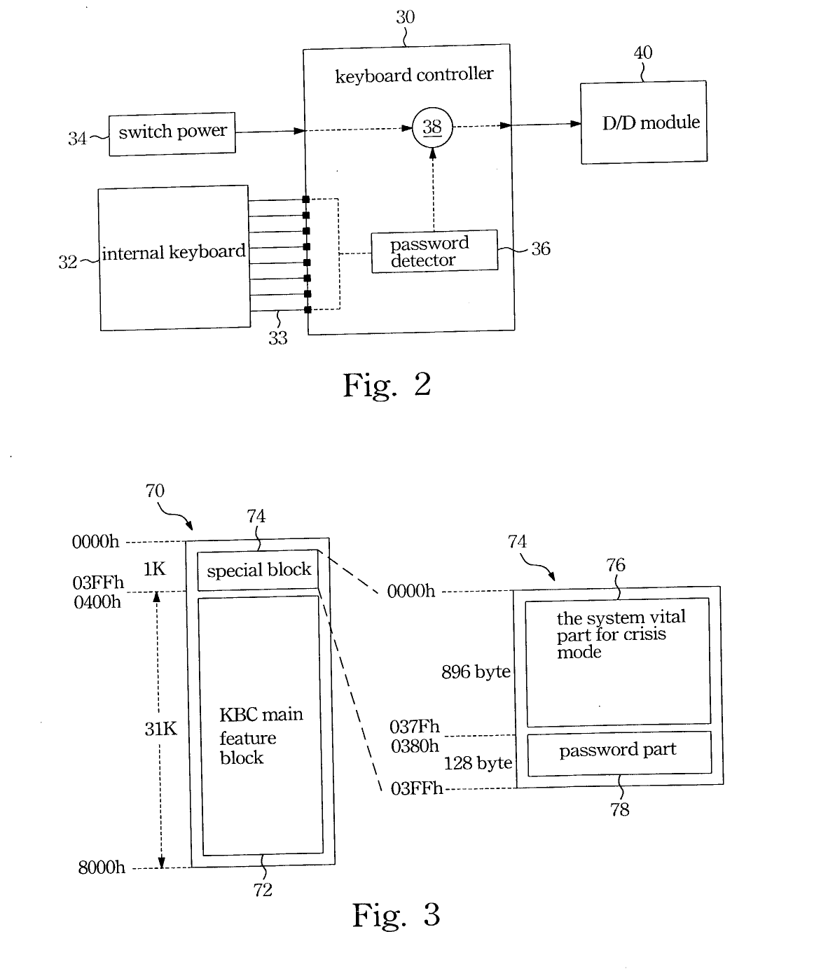

Referring to FIG. 2, it is a configuration diagram according to the preferred embodiment, of the present invention, illustrating the apparatus set on a notebook that may start the booting procedure by inputting the password. The internal keyboard 32 may either provide the user a method to input the password to start the booting procedure or be an interface of operating the notebook to implement a function. The keyboard controller 30 uses the bus 32 to connect with the internal keyboard 32 to store the password and it is also able to respond to the internal keyboard 32 to determine whether the inputted password was correct. A D/D module 40 may respond to the keyboard controller 30 to start the booting procedure when the inputted password is correct. It is important to notice that users may press the power switch power 34 coupled with the keyboard controller 30 to transmit a signal to the D/D module from the keyboard controller 30 to start the booting procedure when the password not being set in the keyboard controller 30.

The keyboard controller 30 further includes a ROM (not shown in the figure) to record the password. A password detector 36 will compare the password inputted from the internal keyboard 32 by users with the password stored in the ROM. When the inputted password is correct, the switch apparatus 38 will transmit a signal to the D/D module 40 to start the booting procedure. Notice that the above switch apparatus 38 is coupled to the power switch 34 and password detector 36 respectively. That means users may press the power switch 34 to start the notebook. However, when the password is stored into the keyboard controller 30, the switch apparatus 38 will end the relative function of the power switch 34 and just accept the users to use the internal keyboard 32 and password detector 36 to start the booting procedure.

Typically, because the ACPI developed by Intel and Microsoft has become the standard on the market, the power supply function of computer systems, especially in the notebook is controlled by the embedded controller, the keyboard controller. Therefore, using the present invention's apparatus in a notebook does not require another special electrical line or device. The keyboard controller produced by Hitachi (H8/3434 TF) can be used to manufacture the password apparatus to start the booting procedure according to the present invention.

Referring to FIG. 3, it shows a configuration diagram illustrating the internal flash ROM 70 of the keyboard controller (H8/3434 TF produced by Hitachi). The internal flash ROM 70 is used to store the set password data due to its characteristics of accessible and upgradable. The internal flash ROM 70 is divided into the special block 74 (address segment from 0000h to 03FFh) and the main feature block 72 (address segment from 0400h to 8000 h) in a prefer embodiment of the present invention. The memory size of the main feature block 72, which stores the operation data of the keyboard controller 30 is about 31 k byte and the main feature block 72 may operate the keyboard controller 30 according to the stored data. On the other hand, the main feature block 72 may update the data according to the users requirement, therefore, it may provide the latest and the best operating function.

The memory size of the above special block 74 is about 1 k bytes and is divided into the systems vital part for crisis mode 76 and the password part 78, wherein the size of the systems vital part for crisis mode 76 is about 896 bytes (address segment from 0000h to 037Fh). The systems vital part for crisis mode 76 may store the non-upgradable system data that may remain the operation systems basic function during the system break. The size of the password part 78 is about 128 byte (address segment from 0380h to 03FFh) and stores the upgradable password data, wherein the password data may be updated or canceled according to the users requirement.

It is important to notice that the keyboard controller coupled to the internal flash ROM in the above preferred embodiment is used to control the function according to the present invention and is produced by Hitachi. However, persons of ordinary skill in the art having reference to this description will be able to apply the present invention's apparatus and method to other keyboard controllers produced by other companies.

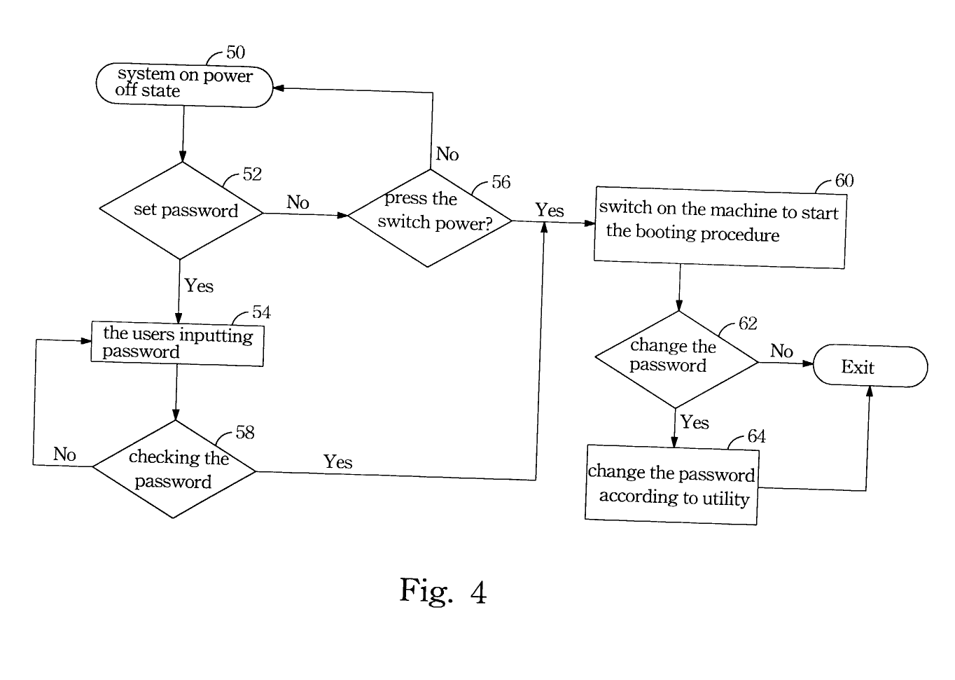

Next, referring to FIG. 4 shows how to apply the keyboard controller to a notebook in order to start a booting procedure step. Firstly, the whole notebook system is in the power off position at step 50. Next, the step will determine the switching on notebook method according to whether the password has been set in the notebook. If the password has not been set, the users may press the power switch at step 56 to start the notebook at step 60. Howver, if the password has been set, the power switch at step 56 will not work and the users must input the set password to start the notebook. The detector in the keyboard controller will determine whether the inputted password is correct at step 58 after the users input the password at step 54. When the inputted password matches the set password, the booting procedure will be started at step 60. Noticed that because of the upgradable characteristic of the password part in the specific block, users are able to start the update password procedure at step 62 when needing to change the password according to the utility provided by the notebook at step 64.

There are many advantages in the present invention. For example, users have to input the set password and then the booting procedure will be started. This will provide the best protection to prevent the production, especially to portable computer productions such as the above notebook, being broken purposely according to the kind of design of the present invention. Therefore, the present invention may prevent the above problems. However, because the password is stored in the ROM of the keyboard controller, the keyboard controller may combine the two kinds of functions, determining the inputted password and starting the boot procedure, which may decrease the opportunity for unauthorized use of notebook computers. Especially, the present invention's production does not require additional memory because the password is stored into the keyboard controller. Therefore, the production cost can be reduced and the abnormal booting procedure because the EEPROM used to be as a password lock is trouble can be avoided.

Although the invention has been described in detail herein, with reference to its preferred embodiment, it is to be understood that this description is by way of example only, and is not to be interpreted in a limiting sense. It is to be further understood that numerous changes in the details of the embodiments of the invention can occur, and additional embodiments of the invention, will be apparent, and may be made by, persons of ordinary skill in the art having reference to this description. For example, although the notebook is used to describe the present invention in the above preferred embodiment, persons of ordinary skill in the art may apply the apparatus and method of the present invention to portable computers or desktop microprocessors. It is considered that such changes and additional embodiments are within the spirit and true scope of the invention as claimed below.

We claim:

1. An apparatus using password lock to start the booting procedure of a microprocessor, said apparatus comprising:
an internal keyboard, providing the users to input the password;
a keyboard controller, storing the set password and to respond to said internal keyboard to determine whether said password inputted by the users is correct; and
a D/D module, responding to said keyboard controller to start the booting procedure of said microprocessor when said users input the correct password.

2. The apparatus of claim 1, wherein said keyboard controller further includes a memory to store said password.

3. The apparatus of claim 2, wherein said memory may be divided into the special block and the main feature block, wherein said main feature block may store the operation function data of said keyboard controller, and said special block may store said password.

4. The apparatus of claim 3, wherein said special block may be divided into the system vital part for crisis mode and the password part, wherein said system vital part for crisis mode stores the non-upgradable system data, and said password part stores said password.

5. The apparatus of claim 4, wherein said password storing in said password part may be updated according to the users requiring.

6. The apparatus of claim 1, wherein said apparatus further includes a power switch power connecting to the keyboard controller, and said keyboard controller may transmit signal to said D/D module to start said booting procedure by pressing said power switch power when said password not being set in said keyboard controller.

7. The apparatus of claim 1, wherein said microprocessor includes a portable computer.

8. An apparatus using password lock to start the booting procedure of a notebook, said apparatus comprising:
an internal keyboard, providing the users to input the password;
a keyboard controller, responding to said internal keyboard to determine whether said password inputted by the users is correct, wherein said keyboard controller further comprising:
a memory, recording the set password;
a password detector, comparing the password inputted by the users with said set password; and
a D/D module, responding to said keyboard controller to start the booting procedure of said notebook when said users input the correct password.

9. The apparatus of claim 8, wherein said memory may be divided into the special block and the main feature block, wherein said main feature block may store the operation function data of said keyboard controller, and said special block may store said password.

10. The apparatus of claim 9, wherein said special block may be divided into the system vital part for crisis mode and the password part, wherein said system vital part for crisis mode stores the non-upgradable system data, and said password part stores said password.

11. The apparatus of claim 10, wherein said password storing in said password part may be updated according to the users requiring.

12. The apparatus of claim 8, wherein said apparatus further includes a power switch power connecting to the keyboard controller, and said keyboard controller may transmit signal to said D/D module to start the booting procedure by pressing said power switch power when said password not being set in said keyboard controller.

13. An apparatus using password lock to start the booting procedure of a notebook, said apparatus comprising:
an internal keyboard, providing the users to input the password;
a keyboard controller, responding to said internal keyboard to determine whether said password inputted by the users is correct, wherein said keyboard controller comprising a memory for recording the set password and said memory further comprising:
a main feature block, storing the operation function data of said keyboard controller;
a special block, including the system vital part for crisis mode and the password part; and
a D/D module, responding to said keyboard controller to start the booting procedure of said notebook when the inputted password by said users match said password.

14. The apparatus of claim 13, wherein said keyboard controller further comprising a password detector to compare the password inputted by the users with said password.

15. The apparatus of claim 13, wherein said system vital part for crisis mode includes the non-upgradable system data.

16. The apparatus of claim 13, wherein said password storing in said password part may be updated according to the users requiring.

17. The apparatus of claim 13, wherein said apparatus further includes a power switch power connecting to the keyboard controller, and said keyboard controller may transmit signal to said D/D module to start the booting procedure by pressing said power switch power when said password not being set in said keyboard controller.

18. A method using password lock to start the booting procedure of a notebook, said method comprising the steps:
inputting the password from a internal keyboard;
checking the keyboard controller to determine whether said keyboard controller stores set password;
comparing said inputted password with said set password if said keyboard controller storing said set password; and
transmitting signal to a D/D module to start the booting procedure if said inputted password match said set password.

19. The method of claim 18, wherein when said keyboard controller does not store said set password, then, checking whether the power switch power is pressed, and said keyboard controller may transmit signal to said D/D module to start the booting procedure when pressing said power switch power.

20. The method of claim 18, wherein said keyboard controller further includes a memory to store said set password.

21. The method of claim 20, wherein said memory may be divided into the special block and the main feature block, wherein said main feature block may store the operation function data of said keyboard controller, and said special block may store said password.

22. the method of claim 21, wherein said special block may be divided into the system vital part for crisis mode and the password part, wherein said system vital part for crisis mode stores the non-upgradable system data, and said password part stores said password.
